(19) United States
(12) Patent Application Publication
(10) Pub. No.: US 2012/0318784 A1
(43) Pub. Date: Dec. 20, 2012

(54) CERAMIC HEATER, AND MANUFACTURING METHOD THEREOF

(75) Inventors: Arata KOBAYASHI, Aichi (JP); Kazuichi HAMADA, Saitama (JP)

(73) Assignee: FUTABA INDUSTRIAL CO., LTD, Aichi (JP)

(21) Appl. No.: 13/524,004

(22) Filed: Jun. 15, 2012

(30) Foreign Application Priority Data
Jun. 15, 2011 (JP) 2011-133303

(51) Int. Cl. H05B 3/02; H01C 17/00

(52) U.S. Cl. 219/538; 29/611

(57) ABSTRACT

A ceramic heater includes a ceramic resistor, at least one metallic film, and at least one foam metal member. The at least one metallic film is formed on at least one surface, of the ceramic resistor, which is assigned as at least one electrode plane. The at least one foam metal member is formed in a plate-like shape. The at least one foam metal member covers and is attached to the at least one metallic film.

### CROSS-REFERENCE TO RELATED APPLICATIONS

This application claims the benefit of Japanese Patent Application No. 2011-133303 filed Jun. 15, 2011 in the Japan Patent Office, the disclosure of which is incorporated herein by reference.

### BACKGROUND

The present invention relates to a ceramic heater provided with a ceramic resistor which is a resistor made of ceramic.

Japanese Unexamined Patent Application Publication No, 9-106883 discloses a ceramic heater which is manufactured as follows. That is, main materials, of the ceramic heater, such as silicon carbide and metallic silicon are first mixed together, added with water, and then kneaded; the resulting mixture is extruded and molded in a honeycomb structure; the molded main materials are sintered, resulting in forming a ceramic resistor. An electrode is formed by applying silver paste having electrical conductivity on a surface of the ceramic resistor and then sintering such a ceramic resistor, or by performing thermal-spraying of pure aluminum onto a surface of the ceramic resistor. The electrode formed as above is pressed by a plate-like electrode presser. An electric wire is connected to the electrode presser.

### SUMMARY

In the above-explained ceramic heater, the following case may occur: due to small concaves and convexes, or wavy swells in the surface of the ceramic resistor on which the electrode is formed, a surface of the electrode is not flat. In this case, even if the electrode presser is pressed against the electrode, electric resistance may be biased depending on portions of the ceramic heater. As a result, a problem may arise in which temperature-rise performance of the ceramic heater is biased depending on the portions of the ceramic heater.

In one aspect of the present invention, it is desirable to provide a ceramic heater in which temperature-rise performance is inhibited from being biased depending on the portions of the ceramic heater.

A ceramic heater according to a first aspect of the present invention includes a ceramic resistor, at least one metallic film, and at least one foam metal member. The at least one metallic film is formed on at least one surface of the ceramic resistor. The at least one surface is assigned as at least one electrode plane. The at least one foam metal member is formed in a plate-like shape. The at least one foam metal member covers and is attached to the at least one metallic film.

In the ceramic heater constituted as above, even if there are concaves and convexes, or swells in the at least one electrode plane of the ceramic resistor, the at least one foam metal member is deformed corresponding to the concaves and convexes or the swells in the at least one electrode plane. For this reason, the at least one metallic film and the at least one foam metal member are attached to each other without forming gaps therebetween. Thus, it is possible to inhibit differences in electric resistance, and therefore, inhibit bias in temperature-rise performance depending on portions of the ceramic heater.

Moreover, the at least one metallic film may be formed in any manners. For example, the at least one metallic film may be formed over an entire area of the at least one electrode plane.

The at least one foam metal member may cover and be attached over an entire area of the at least one metallic film.

The at least one foam metal member may be attached to the at least one metallic film by diffusion-bonding. The diffusion-bonding allows more ensured attachment between the at least one foam metal member and the at least one metallic film without forming gaps therebetween.

Moreover, the at least one foam metal member may be metallically bonded to the at least one metallic film. In this case, the respective contact surfaces of the at least one foam metal member and the at least one metallic film are inhibited from directly contacting with an outer environment, thereby inhibiting increase of electric resistance over time.

The ceramic heater may further include at least one electrode. The at least one electrode is attached to the at least one foam metal member. The at least one electrode has a contact area with the at least one foam metal member smaller than an apparent area of the at least one foam metal member.

In this case, if the contact area between the at least one foam metal member and the at least one electrode is small, electric current can be distributed throughout the entire the ceramic resistor via the at least one foam metal member. Consequently, it is possible to cause the entire ceramic heater to generate heat in a substantially uniform manner. Thus, differences in temperature-rise performance can be suppressed.

The at least one electrode may be attached to the at least one foam metal member in any manners. For example, the at least one electrode may be attached to a generally central region of a surface of the at least one foam metal member so as to stand from the at least one foam metal member in a generally vertical direction.

Moreover, the ceramic resistor may have any shape. For example, the ceramic resistor may be hexahedron shaped. In this case, the at least one metallic film may be two metallic films formed on a pair of opposing surfaces of the ceramic resistor. Furthermore, the at least one foam metal member may be two foam metal members attached respectively to the two metallic films. Furthermore, the at least one electrode may be two electrodes attached respectively to the two foam metal members.

The at least one electrode may be attached to the at least one foam metal member by diffusion-bonding. The diffusion-bonding allows more ensured attachment between the at least one electrode and the at least one foam metal member without forming gaps therebetween.

The at least one electrode may be metallically bonded to the at least one foam metal member. In this case, the respective contact surfaces of the at least one electrode and the at least one foam metal member are inhibited from directly contacting with an outer environment, thereby inhibiting increase of electric resistance over time.

The ceramic resistor may have any shape, and for example, may have a honeycomb shape. The ceramic resistor formed in a honeycomb shape allows a fluid to flow through inside the ceramic resistor and thus, to increase a temperature of the fluid flowing through thereinside.

A method for manufacturing a ceramic heater according to a second aspect of the present invention includes a step of forming at least one metallic film on at least one surface of a ceramic resistor, and a step of placing and attaching at least one foam metal member, which is formed in a plate-like shape, over the at least one metallic film.

According to the above manufacturing method, it is possible to manufacture the ceramic heater in the first aspect, and therefore, provide a ceramic heater in which temperature-rise performance is inhibited from being biased depending on portions of the ceramic heater.

### BRIEF DESCRIPTION OF THE DRAWINGS

The invention will now be described below, by way of example, with reference to the accompanying drawings, in which:

FIG. 1 is a partially cut-away perspective view of a duct to which a ceramic heater according to one embodiment of the present invention is incorporated; and

FIG. 2 is an exploded perspective view of the ceramic heater.

### DETAILED DESCRIPTION OF THE PREFERRED EMBODIMENTS

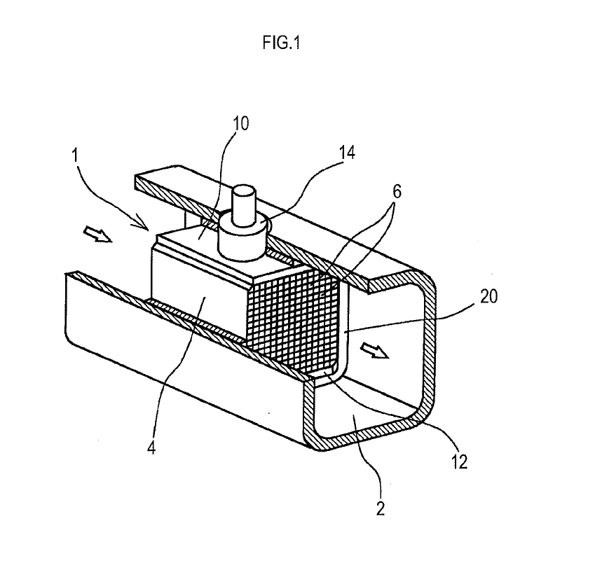

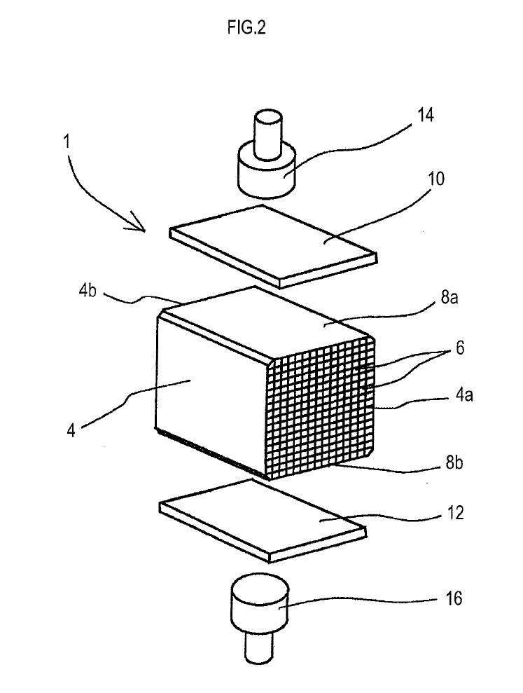

As shown in FIGS. 1 and 2, a ceramic heater 1 is housed inside a duct 2. In the present embodiment, a fluid which is to be flowed through inside the duct 2 is air. However, the fluid is not limited to air, and may be a gas other than air or may be a liquid such as water, etc.

The ceramic heater 1 includes a ceramic resistor 4 having a generally honeycomb structure. More specifically, the ceramic resistor 4 of the present embodiment is divided by a plurality of longitudinal ribs and a plurality of lateral ribs in a grid-like manner, so that a plurality of rectangular through holes 6 are formed in the ceramic resistor 4.

The ceramic resistor 4 constituted as above is formed as follows: main materials such as silicon carbide and metallic silicon are first mixed together, added with water, and then kneaded; the resulting mixture is extruded and molded into a honeycomb structure; the molded main materials in honeycomb structure are reacted and sintered in a furnace under a nitrogen (inert gas) atmosphere; and as a result, the ceramic resistor 4, which is a composite of silicon carbide and silicon nitride, is formed.

The ceramic resistor 4 has electrical conductivity, and is porous as explained above. In the present embodiment, the ceramic resistor 4 has an appearance of a cuboid shaped hexahedron. The through holes 6 have openings at end surfaces 4a and 4b of the ceramic resistor 4. The through holes 6 penetrate through the ceramic resistor 4 in a longitudinal direction of the ceramic resistor 4. Four surfaces of the ceramic resistor 4, which do not include the end surfaces 4a and 4b, are flat without a through hole.

Among the four surfaces, two opposing surfaces are assigned as a plane for an electrode (hereinafter referred to as “electrode plane”). Metallic films 8a and 8b are formed respectively on these two electrode planes. In the present embodiment, the metallic films 8a and 8b are formed over entire areas of the electrode planes. The metallic films 8a and 8b as such may be formed by applying silver paste having heat-resistance, and electrical conductivity on the electrode planes and thereafter sintering the ceramic resistor 4 at a high temperature. Alternatively, the metallic films 8a and 8b may be formed by performing thermal-spraying of pure aluminum onto the electrode planes.

Plate-like foam metal members 10 and 12 cover and are attached to the metallic films 8a and 8b, respectively. The foam metal members 10 and 12 are formed respectively in sizes sufficient to cover entire surfaces of the respective metallic films 8a and 8b.

The foam metal members 10 and 12 are formed as below. Firstly, metallic powder, water-soluble binder, surfactant, and water are mixed together. Then, a non-water soluble organic solvent is further added to and mixed with the resulting mixture. Consequently, a compact in which all of the mixed materials are evenly dispersed and distributed is formed. By holding this compact at a constant temperature, the non-water soluble organic solvent contained in the compact is gasified and evaporated as a gas.

As a result of this evaporation, a plurality of very fine and uniformly-sized air bubbles are generated inside the compact, thereby forming the foam metal members 10 and 12. The foam metal members 10 and 12 formed as above are sintered at a high temperature so as to sinter portions consisting of the metallic powders. Consequently, such sintered foam metal members 10 and 12 become a porous metal body having electrical conductivity. The porous metal body is composed of framework structures which enclose air pores formed by the air bubbles. As a material of the metallic powders, it is preferable to use a material having an excellent electrical conductivity, such as copper-based or aluminum-based materials. Moreover, it is preferable to form the foam metal members 10 and 12 to be soft. Furthermore, a diameter of the air pores in the foam metal members 10 and 12 and a porosity of the foam metal members 10 and 12, may be preferably determined by experiments, etc.

In the present embodiment, the foam metal members 10 and 12 are attached, respectively, to the metallic films 8a and 8b by diffusion-bonding where the metallic films 8a and 8b and the foam metal members 10 and 12 are heated while being pressed against each other. The diffusion bonding causes interdiffusion between these metals which are in contact with each other.

Since the metallic films 8a and 8b are formed on the ceramic resistor 4, the ceramic resistor 4 can be diffusion-bonded to the foam metal members 10 and 12, respectively, via the metallic films 8a and 8b. Moreover, since there may be small concaves and convexes, or small wavy swells in the electrode planes of the ceramic resistor 4, these electrode planes may be coarse or have a low flatness.

In the ceramic heater 1, even if there are concaves and convexes or swells in the electrode planes on which the metallic films 8a and 8b are to be formed, the foam metal members 10 and 12 can be closely attached, respectively, to the metallic films 8a and 8b without forming gaps therebetween. This is because, at the time when the foam metal members 10 and 12 are diffusion-bonded to the respective metallic films 8a and 8b, the foam metal members 10 and 12 are deformed corresponding to the concaves and convexes or the swells in the electrode planes.

For example, the small convexes in the electrode planes are entered into the air pores formed in attachment surfaces of the foam metal members 10 and 12. Alternatively, the small convexes are pressed into the attachment surfaces of the foam metal members 10 and 12. In this case, the concaves and convexes in the electrode planes are absorbed, and thus, entire surfaces of the foam metal members 10 and 12 are closely attached to the metallic films 8a and 8b, respectively.

Moreover, even if there is a swell in the electrode planes, the foam metal members 10 and 12 are deformed along the swell. Thus, the entire surfaces of the foam metal members 10 and 12 are closely attached to the metallic films 8a and 8b, respectively.

A metal electrode 14 is attached to a generally central region of a surface of the plate-like foam metal member 10. Likewise, a metal electrode 16 is attached to a generally central region of a surface of the plate-like foam metal member 12. In the present embodiment, the electrodes 14 and 16 are attached, respectively, to the foam metal members 10 and 12 by diffusion-bonding.

An attachment area between the electrode 14 and the foam metal member 10 is smaller than an apparent area of the foam metal member 10. Likewise, an attachment area between the electrode 16 and the foam metal member 12 is smaller than an apparent area of the foam metal member 12.

The electrodes 14 and 16 are provided to stand from the respective surfaces of the foam metal members 10 and 12 in a generally vertical direction. The surfaces of the foam metal members 10 and 12 consist of metal portions and air-pore portions. Specifically, in the surfaces of the foam metal members 10 and 12, the metal portions and the air-pore portions are positioned in an alternating manner.

The apparent area of the foam metal member 10 is an entire area of one surface of the foam metal member 10. The one surface of the foam metal member 10 includes both of the metal portions and the air-pore portions, and faces to the electrode 14. Likewise, the apparent area of the foam metal member 12 is an entire area of one surface of the foam metal member 12. The one surface of the foam metal member 12 includes both of the metal portions and the air-pore portions, and faces to the electrode 16.

The above attachment areas are smaller than the respective apparent areas of the foam metal members 10 and 12. The above attachment areas are respective regions including both of the metal portions and the air-pore portions of the respective foam metal members 10 and 12.

An attachment operation of three types of components (i.e., the metallic films 8a and 8b, the foam metal members 10 and 12, and the electrodes 14 and 16) can be facilitated by the following procedure: firstly, overlaying the foam metal member 10 onto the metallic film 8a formed on the ceramic resistor 4; then, further overlaying the electrode 14 onto the above foam metal member 10; and performing diffusion-bonding to the metallic film 8a, the foam metal member 10, and the electrode 14, at the same time. The attachment operation of the metallic film 8b, the foam metal member 12, and the electrode 16 can be facilitated by the same procedure as above.

Since the aforementioned three types of components have been diffusion-bonded, a contact surface between the metallic film 8a and the foam metal member 10, and a contact surface between the foam metal member 10 and the electrode 14, are closely attached and metallically bonded to each other. Similarly, a contact surface between the metallic film 8b and the foam metal member 12, and a contact surface between the foam metal member 12 and the electrode 16, are closely attached and metallically bonded to each other.

As above, since the contact surfaces do not directly come into contact with an outer environment, increase in electric resistance over time may be suppressed.

If the contact surfaces are not metallically bonded to each other, electric resistance increases depending on portions of the ceramic heater 1 due to oxide layer generated over time in the contact surfaces. If the electric resistance varies depending on the portions of the ceramic heater 1, temperature-rise performance of the ceramic heater 1 may be biased depending on portions of the ceramic heater 1.

On the other hand, if the contact surfaces are closely attached and metallically bonded to each other, bias in temperature-rise performance may be suppressed.

To use the ceramic heater 1, the ceramic heater 1 is to be covered by a flexible mat 20 which is not electrically conductive. Specifically, the ceramic heater 1 is covered by the mat 20 such that the end surfaces 4a and 4b of the ceramic resistor 4 are not covered and that the surfaces of the foam metal members 10 and 12 are covered. The electrodes 14 and 16 are projected outward from the mat 20.

The ceramic heater 1 covered by the mat 20 is housed inside the duct 2. Each of the electrodes 14 and 16 is projected outward from the duct 2 and connected to a cable. When the electrodes 14 and 16 are energized, the ceramic resistor 4 generates heat. Therefore, a fluid flowing through inside the duct 2 is heated by flowing through inside the through holes 6.

When the electrodes 14 and 16 are energized, electric current flows from the electrodes 14 and 16 to the ceramic resistor 4 through the foam metal members 10 and 12 and then the metallic films 8a and 8b. In the present embodiment, the metallic films 8a and 8b are formed on the opposing electrode planes of the ceramic resistor 4. Therefore, a distance between the metallic films 8a and 8b in an energizing direction is uniform. Consequently, current-carrying can be uniformed.

Moreover, in the case that the attachment areas between the foam metal members 10 and 12 and the respective electrodes 14 and 16 are small, a resistance value of the foam metal members 10 and 12 can be sufficiently made lower than a resistance value of the ceramic resistor 4. Therefore, electric current can be distributed throughout an entire area of the ceramic resistor 4 via the foam metal members 10 and 12. Consequently, it is possible to cause the entire ceramic resistor 4 to generate heat in a substantially uniform manner.

The foam metal members 10 and 12 have a lighter weight than a metal plate having a volume the same as a volume of the foam metal members 10 and 12. Moreover, the electrodes 14 and 16 can be formed in a smaller size. As above, it is possible to reduce a weight of the ceramic heater 1.

As explained above, since the ceramic heater 1 can be made compact in size, the ceramic heater 1 can be used to warm up a small room such as a vehicle interior and a bathroom, etc. or to warm up a specific spot in an area.

The present invention should not be limited to the above-explained embodiment. Rather, the present invention can be implemented in various manners without departing from the scope of the present invention.

What is claimed is:

1. A ceramic heater comprising:
a ceramic resistor;
at least one metallic film that is formed on at least one surface of the ceramic resistor, the at least one surface being assigned as at least one electrode plane; and
at least one foam metal member that is formed in a plate-like shape, the at least one foam metal member covering and being attached to the at least one metallic film.

2. The ceramic heater according to claim 1,
wherein the at least one metallic film is formed over an entire area of the at least one electrode plane.

3. The ceramic heater according to claim 1,
wherein the at least one foam metal member covers and is attached over an entire area of the at least one metallic film.

4. The ceramic heater according to claim 1,
wherein the at least one foam metal member is attached to the at least one metallic film by diffusion-bonding.

5. The ceramic heater according to claim 1,
wherein the at least one foam metal member is metallically bonded to the at least one metallic film.

6. The ceramic heater according to claim 1, further comprising:
at least one electrode being attached to the at least one foam metal member and having a contact area with the at least one foam metal member smaller than an apparent area of the at least one foam metal member.

7. The ceramic heater according to claim 6,
wherein the at least one electrode is attached to a generally central region of a surface of the at least one foam metal member so as to stand from the at least one foam metal member in a generally vertical direction.

8. The ceramic heater according to claim 6,
wherein the ceramic resistor is hexahedron shaped;
wherein the at least one metallic film is two metallic films formed on a pair of opposing surfaces of the ceramic resistor;
wherein the at least one foam metal member is two foam metal members attached respectively to the two metallic films; and
wherein the at least one electrode is two electrodes attached respectively to the two foam metal members.

9. The ceramic heater according to claim 6,
wherein the at least one electrode is attached to the at least one foam metal member by diffusion-bonding.

10. The ceramic heater according to claim 6,
wherein the at least one electrode is metallically bonded to the at least one foam metal member.

11. The ceramic heater according to claim 1,
wherein the ceramic resistor is formed in a honeycomb shape.

12. A method for manufacturing a ceramic heater, comprising the steps of:
forming at least one metallic film on at least one surface of a ceramic resistor; and
placing and attaching at least one foam metal member, which is formed in a plate-like shape, over the at least one metallic film.
